(19) United States
(12) Patent Application Publication
(10) Pub. No.: US 2026/0311315 A1
(43) Pub. Date: Oct. 8, 2026

(54) SEMICONDUCTOR PROCESS AND DEVICE IMAGING AND INSPECTION

(71) Applicant: Taiwan Semiconductor Manufacturing Company, LTD., Hsinchu (TW)

(72) Inventors: Yin Yuan Chen, Changhua (TW); Yu-Hung Lin, Hsinchu (TW); Cheng-Kang Ku, Kaohsiung (TW); Hsu-Shui Liu, Pingjhen (TW); Jiun-Rong Pai, Jhubei (TW)

(21) Appl. No.: 19/172,921

(22) Filed: Apr. 8, 2025

(51) Int. Cl. G06T 7/00; G06T 7/73; H04N 23/90

(52) U.S. Cl. CPC G06T 7/0004; G06T 7/73; H04N 23/90; G06T 2207/30148

(57) ABSTRACT

A semiconductor process imaging and inspection method, apparatus and system for performing optical inspection of semiconductor wafers to detect physical features, e.g. defects or other semiconductor process results. In some suitable embodiments, imaging and optical inspection as disclosed herein simultaneously rotates at a constant rotational speed a wafer stage including a wafer attached thereto, and radially images the wafer along a scan line that extends across the radius of the wafer. A wafer edge shift detector method, apparatus and/or system is integrated with the image capture process to laterally adjust the position of the wafer stage, and wafer attached thereto, to compensate for any wafer shift detected and realign the wafer center line relative to a camera/camera's field of view (FIV), thereby providing a complete radial line scan of the rotating wafer.

### BACKGROUND

The following relates to the semiconductor arts, and in particular, to methods, apparatus and systems for the imaging and/or inspection of semiconductor processes and devices, e.g., semiconductor wafers and dies, during the manufacturing process.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a front view of a semiconductor processing system including a semiconductor process/wafer imaging and/or inspection apparatus according to an example embodiment of this disclosure (Embodiment 1; 1001).

FIG. 1B is a perspective view of another semiconductor processing system including a semiconductor process/wafer imaging and/or inspection apparatus according to an example embodiment of this disclosure (Embodiment 1), the semiconductor process/wafer imaging and/or inspection apparatus including a rotatable wafer platform, a radial scanning camera, e.g. line scanning camera, and a bar light mounted above a wafer to be rotatably imaged.

FIG. 1C is an illustration of an example series of processes used to perform a radial scan of a wafer to generate an image of a wafer for inspection of defects or other features according to an example embodiment of this disclosure.

FIG. 1D is another illustration of a semiconductor process/wafer imaging and/or inspection apparatus according to an example embodiment of this disclosure, FIG. 1D showing the arrangement of a line scan camera relative to a rotating wafer for radially imaging the wafer to generate a complete image of the wafer for inspection of the wafer.

FIGS. 1E, 1F, 1G, 1H and 1I provide further detailed illustrations of a semiconductor process/wafer imaging and/or inspection apparatus according to an example embodiment of this disclosure, the example embodiment shown including a wafer shift sensor to detect a lateral linear shift of a rotating wafer, where the lateral position of the wafer stage is moved along the X-axis based on a wafer shift detection to realign the wafer center line with the camera field of view, thereby providing a consistent invariable alignment of the camera field of view with the wafer for image acquisition.

FIG. 2 is a flow chart of a semiconductor process/wafer imaging and/or inspection method according to an example embodiment of this disclosure (Embodiment 2; 2001), the method including the use of a single camera to radially image a wafer rotating at a constant speed where wafer shift is monitored and compensated for by laterally moving a wafer stage to realign the wafer.

FIGS. 3A and 3B are perspective views of another semiconductor process/wafer imaging and/or inspection apparatus according to an example embodiment of this disclosure (Embodiment 3; 3001), the semiconductor process/wafer imaging and/or inspection apparatus including a rotatable wafer platform, first and second radial scanning cameras, e.g. line scanning camera, and a bar light mounted above a wafer to be rotatably imaged.

FIG. 3C is a detailed view of a wafer stage according to an example embodiment of this disclosure.

FIG. 3D is a detailed perspective view of a wafer stage according to an example embodiment of this disclosure.

FIGS. 3E and 3F are other detailed perspective views of a wafer stage according to an example embodiment of this disclosure, these views also show the mounting of a single camera relative to a rotatable wafer stage.

FIG. 3G is an exploded view and FIG. 3H is a front view of a semiconductor process/wafer imaging and/or inspection apparatus according to an example embodiment of this disclosure, the semiconductor process/wafer imaging and/or inspection apparatus including a rotatable wafer platform, first and second radial scanning cameras, e.g. line scanning cameras, and a bar light mounted above a wafer to be rotatably imaged.

FIG. 3I is an illustration of a compete image of a radially imaged wafer according to an example embodiment of this disclosure.

FIG. 3J is a diagram of the line scan areas, LS1 and LS2, associated with respective line scan cameras used to capture a complete radial image of a wafer according to an example embodiment of this disclosure.

FIG. 3K shows a portion of an accumulated line scan LS1 image acquired while the wafer and wafer stage are rotated at a constant speed, prior to processing the acquired radial images to generate an actual area image of the wafer which includes a physical shape scaled and/or proportional to the wafer.

FIG. 3L shows a complete wafer area image generated by further processing of the captured radial images, e.g., FIG. 3K, where the line pixels are rotated by the angular position of the stage platform when each of the radial line pixels were captured.

FIG. 3M shows another complete wafer area image generated by further processing of the captured radial images, e.g., FIG. 3K, where the line pixels are rotated by the angular position of the stage platform when each of the radial line pixels were captured, and an inspection process detects a wafer feature, e.g., defect, within the image.

FIG. 4 is a flow chart of a semiconductor process/wafer imaging and/or inspection method according to an example embodiment of this disclosure (Embodiment 4; 4001), the method including the use of a first and a second camera to radially image a wafer rotating at a constant speed where wafer shift is monitored and compensated for by laterally moving a wafer stage to realign the wafer.

FIG. 5 is a block diagram of a semiconductor process/wafer imaging and/or inspection system according to an example embodiment of this disclosure (Embodiment 5; 5001).

FIG. 6 is a flow chart of another semiconductor process/wafer imaging and/or inspection method according to an example embodiment of this disclosure.

FIG. 7 is a flow chart of another semiconductor process/wafer imaging and/or inspection method according to an example embodiment of this disclosure.

FIG. 8 is a flow chart of another semiconductor process/wafer imaging and/or inspection method according to an example embodiment of this disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g., “about 2 to about 4” also discloses the range “from 2 to 4.” The term “about” may refer to plus or minus 10% of the indicated number.

The term “substrate” herein generally refers to the bulk substrate on which various layers and device structures are formed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “orthogonal axis,” as used herein, refers to an axis substantially or about at 90 degrees relative to a longitudinal axis of a structure.

The term “front side” and “back side” as used herein, relate to a semiconductor wafer or other imaged or inspected surface and refer to a first side and a back side, opposite the first side, without any limitation to a particular orientation related to the relative conventional meaning of “top” and “bottom.”

The term “inspected,” “inspection” and “analysis” as these terms are used herein, are synonymous and refer to one or more of an automated or manual optical or other image based inspection of a surface, e.g., wafer surface, semiconductor die, etc.

The term “feature” and “features,” as used herein refer to one or more physical attributes or characteristics of an imaged surface, such as a wafer surface, to identify physical attributes or characteristics that are defined by a specific or predetermined criteria for the identification of one or more of wafer defects, die defects, semiconductor process results, etc.

The term “R-theta scanning,” as used herein, refers to a non-destructive pixel scan that uses a two axis scanner configuration to capture data in a circular pattern or rotating pattern. The scan is performed by encoding the radial (R) and rotational (0) axes.

The term “line scan compilation” as herein, refers to the process of combining multiple individual line scans, which are essentially single horizontal slices of an image, to create a complete two-dimensional image by sequentially capturing each line and arranging them together in order.

Modern day integrated chips comprise millions or billions of semiconductor devices formed on a semiconductor substrate (e.g., silicon). Integrated chips (ICs) may use many different types of semiconductor devices, depending on an application of an IC.

To manufacture ICs and/or IC dies, a plurality of semiconductor chip regions are marked on a substrate by scribe lines between chip regions. The substrate goes through a variety of cleaning, layering, patterning, etching and doping steps to form integrated circuits. In some embodiments, the bulk substrate includes silicon or a compound semiconductor, such as GaAs, InP, Si/Ge, or SiC. Examples of such layers include dielectric layers, doped layers, polysilicon layers or conductive layers. Examples of device structures include transistors, resistors, and/or capacitors, which may be interconnected through an interconnect layer to additional integrated circuits.

In general, there is disclosed herein methods, apparatus and systems for the imaging and/or inspection of semiconductor processes and devices, e.g., semiconductor wafers during the manufacturing process. According to a nonlimiting example embodiment described herein, provided are methods, apparatus and systems for performing optical inspection of semiconductor wafers to detect physical features, e.g. defects or other semiconductor process results, such as where the semiconductor wafer under test sufficiently deviates from an intended design or the like at a given location being inspected, for example, at a given die or cell formed or defined on the semiconductor wafer. Other defect condition examples are associated with underfill, plating, molding, bonding, contaminant particles, scratches, bulges, abnormal fill, cracks and chipping.

In some suitable embodiments, imaging and optical inspection, as disclosed herein, simultaneously rotates a wafer stage, including a wafer attached thereto, at a constant rotational speed, illuminates the semiconductor wafer with a light source, and radially images the wafer along a scan line that extends across the diameter, radius, or portion of the diameter or radius of the wafer. In order to provide a concentric rotation of the wafer as the radial line images are captured, a wafer edge shift detector method, apparatus and/or system is integrated with the image capture process to laterally, i.e., linearly, adjust the position of the wafer stage, and wafer attached thereto, to compensate for any wafer shift detected. To compensate for any wafer shift detected, the wafer center line is realigned relative to a camera/camera's field of view (FOV), thereby providing a complete radial line scan of the rotating wafer that includes a plurality of line scan pixel images directly referenced or correlated to an invariable wafer radial position coordinate system, such as a polar coordinate system, for inspection purposes and/or further processing for generating a more realistic actual 2-dimensional area image representation of the radially imaged wafer which is consistent or scaled to the shape of the wafer, i.e. circular.

Advantageously, the imaging and inspection methods, apparatus and systems disclosed herein decrease the required area of linear travel required for wafer imaging and/or inspection, as compared to a wafer scanning method that includes a linear translation of a wafer stage to perform a complete scan of a wafer surface for inspection, where the wafer stage is not rotating during the scan process. In other words, in the case of a nonrotating wafer scan, the wafer stage is required to linear travel the diameter of the wafer to capture a complete image, for example 300 mm for a 12 inch wafer, thereby requiring an area of approximately 600 mm in length for the wafer scanning process. In contrast, the disclosed rotating scanning methods, apparatus and systems only require an area length of about the diameter of the wafer, e.g., 300 mm for a 12 inch wafer, plus any linear travel required for wafer shift as the wafer rotates which will be further described herein. The reduced area required to scan a wafer for generating an image of the wafer reduces the physical footprint required for incorporating a wafer image scanning system into a semiconductor manufacturing process, thereby enabling the inspection of semiconductor wafers and dies at various locations throughout the semiconductor process for an improved quality assurance process.

The example embodiments described herein specifically relate to the scanning and imaging of semiconductor wafers and are described with reference thereto, however it is to be understood that disclosed embodiments are not limited to the imaging and/or inspection of semiconductor wafers and can be applied to the imaging and/or inspection of any rotatable substrate or platform for imaging, for example but not limited to, photomasks, wafer stage tables, other circular shaped devices, etc.

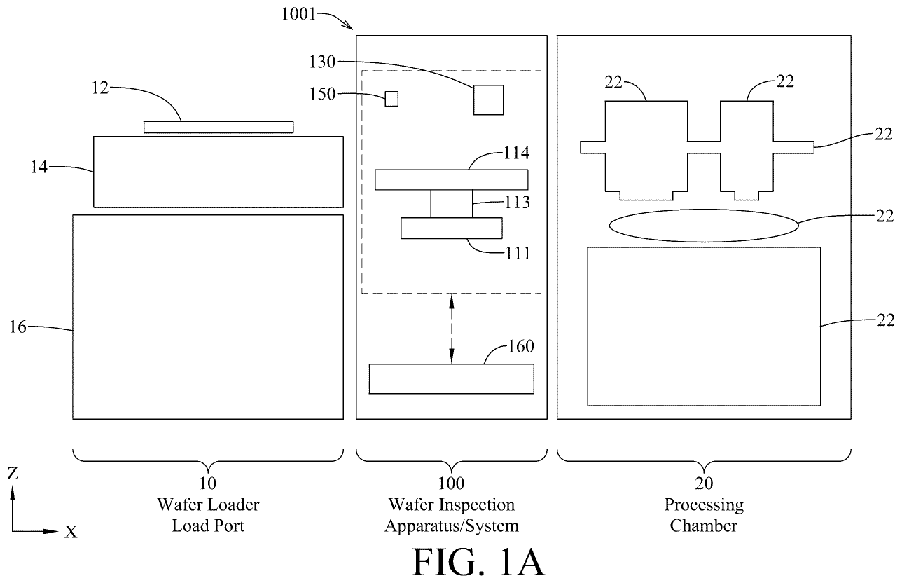

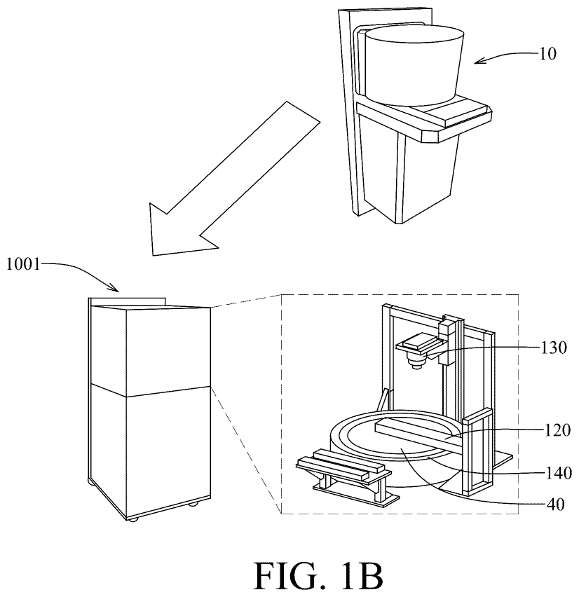

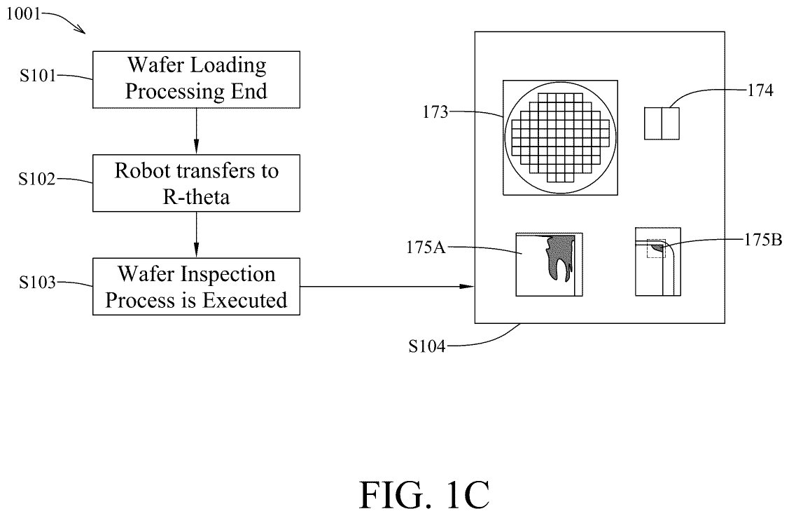

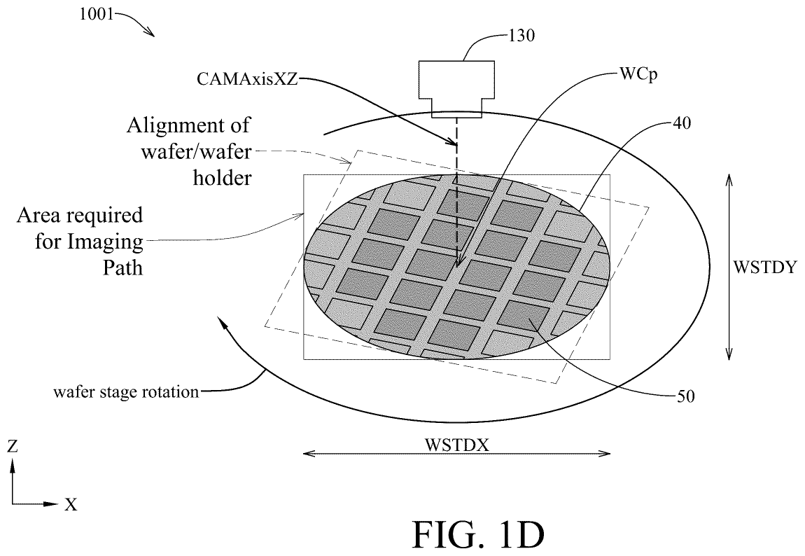

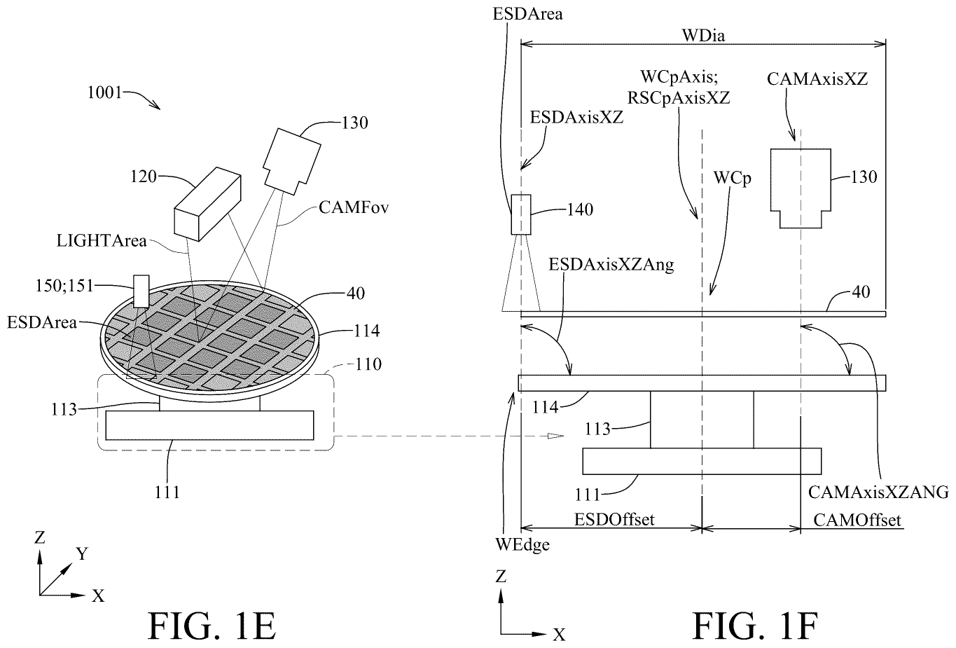

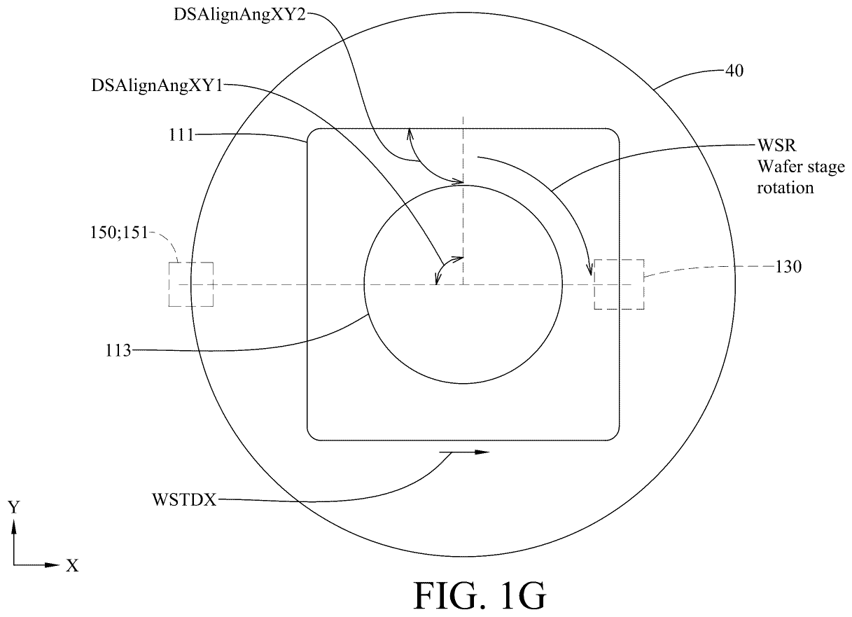

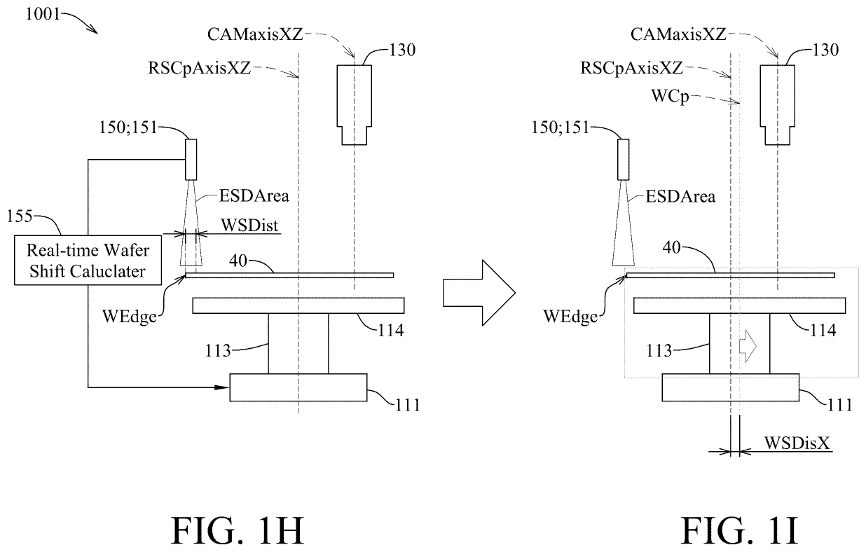

With reference to FIGS. 1A-1I, illustrated are various views of a semiconductor processing apparatus including a semiconductor process/wafer imaging and/or inspection apparatus according to an example embodiment of this disclosure (Embodiment 1; 1001).

FIG. 1A is a front view of the semiconductor processing system including a semiconductor process/wafer imaging and/or inspection apparatus according to an example embodiment of this disclosure (Embodiment 1; 1001). The system shown is provided to merely provide an example environment of which the disclosed semiconductor process/wafer imaging and/or inspection apparatus can be integrated and is not intended to limit the location of the disclosed imaging and/or inspection process disclosed herein.

As shown, the example system includes a semiconductor processing arrangement having a wafer loader apparatus/system 10 with a wafer cassette head 12, wafer cassette 14 and a wafer load port 16. The wafer loader apparatus/system 10 loads one or more wafers for imaging and/or inspection into a wafer inspection apparatus/system 100 as disclosed herein, the wafer inspection apparatus/system 100 having a wafer stage 114, a stage rotation connector/coupler 113, an X axis directional stage 111, a camera 130, e.g. high resolution CCD (charge-coupled device), a real time wafer edge shift detector 150 and a controller 160 which communicates with the other components of the wafer inspection apparatus/system 100 for executing wafer surface imaging. The controller 160 executes computer program instructions to rotate the wafer stage 114, control the camera(s) 130 for image acquisition of the wafer top and/or bottom side surfaces, control the wafer stage X-axis position while monitoring the wafer shift subsystem, and in some example embodiments, further processes the captured radial images to generate a complete 2D area scan image of the wafer surface. Depending on the results of the wafer inspection process, the wafer is then transferred to the processing chamber system 20 which includes a variety of semiconductor processing components 22 for processing the semiconductor wafer to fabricate various devices, and/or perform advance packaging processes.

With reference to FIG. 1B, shown is a perspective view of another semiconductor processing system including a semiconductor process/wafer imaging and/or inspection apparatus 1001 according to an example embodiment of this disclosure (Embodiment 1). The system shown is provided to merely provide another example environment of which the disclosed semiconductor process/wafer imaging and/or inspection apparatus can be integrated and is not intended to limit the location of the disclosed imaging and/or inspection process disclosed herein. The semiconductor process/wafer imaging and/or inspection apparatus 1001 includes a rotatable wafer platform with a wafer 40 attached thereto, a radial scanning camera 130, e.g., line scanning camera, and a bar light 120 mounted above the wafer 40 to be rotatably imaged. An encoder 140, e.g., optical encoder with an accuracy of about 0.15 um, is used to detect/measures the angular position of the wafer, e.g., 0-360 degrees, etc. during the radial line imaging process and the optical encoder 140 is used to monitor and control the rotational speed of the wafer 40 attached to a wafer stage. A wafer loader apparatus/system 10 provides the storage and loading of wafers 40 into the semiconductor process/wafer imaging and/or inspection apparatus 1001.

With reference to FIG. 1C, illustrated is an example series of processes used to perform a plurality of radial line scans of a wafer to generate an image of a wafer for inspection of defects or other features according to an example embodiment of this disclosure. The example wafer imaging processes includes the following:

At step S101, a wafer is loaded by a wafer loader system into a processing chamber associated with a wafer radially imaging apparatus as disclosed herein.

At step S102, a wafer handling apparatus or system, e.g., robot arm or transport, transfers a wafer for imaging and inspection to a R-theta scanning apparatus for radially scanning of the surface to generate a plurality of radial line scans, which are compiled to generate a composite line scan image of the wafer surface area.

At step S103, a wafer inspection process is executed which generates a radial line scan compilation which is representative of the actual shape or scaled to the actual shape of the wafer surface imaged. At step S103 and/or S104, inspection processes are performed to analyze the 2D area scan image generated to identify any features in the image which are considered of interest, such as defects. It is to be understood that one or more processes described here with reference to S103 and S104 may be included in the R-theta scanning step S102.

The image output of S104 includes the generated wafer 2D area scan which includes images of a plurality of acceptable dies 174 and images of dies that may include defect features 175A and 175B.

FIG. 1D is another illustration of a semiconductor process/wafer imaging and/or inspection apparatus according to an example embodiment of this disclosure (Embodiment 1), FIG. 1D showing the arrangement of a single line scan camera 130 relative to a rotating wafer 40 including a plurality of dies 5. The arrangement radially imaging a rotating wafer to generate a complete image, e.g. 16K per camera/32K total pixel resolution, of the wafer for inspection of the wafer. As shown, and previously discussed, the area required for the inspection/imaging path (WSTDX and WSTDY) is minimized to the diameter of the wafer 40 being imaged and inspected.

As shown in FIG. 1D, a center line of a camera 130 is aligned along an axis CAMAxisXZ at an alignment angle CAMAxisXZAng which is substantially orthogonal or perpendicular to the wafer surface, and the camera 130 center line is directly aligned with the wafer center line or wafer center point WCp to be imaged and inspected. While not shown in this figure, a field of view (FOV) associated with the camera 130 includes the entire diameter or width of the wafer 40. According to an example embodiment including a single camera covering the entire diameter of an imaged wafer, only a 180 degree rotation of the wafer is required to acquire a complete image of the wafer surface.

According to an example embodiment, the camera align axis CAMAxisXZ distance is calculated as ½ the wafer radius offset from the wafer center WCp.

With reference to FIGS. 1E, 1F, 1G, 1H and 1I, provided are further detailed illustrations of a semiconductor process/wafer imaging and/or inspection apparatus according to an example embodiment of this disclosure, the example embodiment shown including a camera 130, and a wafer shift sensor 150:151 to detect a lateral shift WSDist of a rotating wafer 40 in a direction WSR where the lateral position of the wafer stage 114 is moved along the X-axis by a X directional motor 112 and stage rotation connector/coupler 113 arrangement. The X-axis movement distance is based on any wafer shift detected by the wafer shift sensor which initiates a realignment of the wafer center line relative to the camera 130/camera FOV, thereby providing a consistent invariable alignment of the camera field of view with the wafer for image acquisition.

Other components and features of the illustrated semiconductor process imaging and inspection apparatus shown in FIGS. 1E-1I include a light source 120, e.g. light bar, to illuminate a wafer area LIGHTArea aligned with the camera 130 FOV CAMFov, and a wafer edge detector 150 including a CCD camera 151 arrangement for capturing images of the wafer edge WEdge within a wafer edge detection area ESDArea. According to an example embodiment of this disclosure, the wafer edge detector is a 10 um/pixel resolution CCD camera with a 100 mm×100 mm field of view.

As shown in FIGS. 1E and 1F, the camera 130 is offset from a center line axis WCpAxis and RSCpAxisSXZ of the wafer 40 and rotating stage 114, respectively, by an offset distance CAMOffset which is about ½ the radius of the wafer or a ¼ of the diameter of the wafer WDia, thereby providing a camera FOV CAMFov that includes a radial line extending from the center of the wafer WCp to the wafer edge WEdge. The edge detector sensor 150 is aligned along axis ESDAxisXZOffset at an angle ESDAxisXZAng, relative to the rotating stage 114, from the wafer center WCp by an offset distance of ESDOffset with is equal to or about the radius of the wafer 40. Referring to FIG. 1G, it is shown that the camera 130 and wafer edge detector sensor 150 are aligned relative to the X directional stage at angles DSAlignAngXY1 and DSAlignAngXY2 which are equal to or about 90 degrees.

With reference to FIGS. 1H and 1I, further details of the wafer shift detection arrangement are shown, including an example wafer shift distance WSDist detected within wafer edge detection area ESDArea, where a real-time wafer shift calculator 155 algorithm is executed using compute instructions to determine the appropriate X directional move of the X directional stage 111 to compensate for the wafer shift distance and realign the wafer center with the camera 130. According to an example embodiment, a predetermined threshold of wafer shift distance can be used before initiating movement of the wafer stage to compensate for wafer shift.

According to an example embodiment of this disclosure, the wafer shift detection sensor 150 is a camera, such as a CCD camera, and the camera pixels are calibrated or mapped to correlate with physical X dimensional lengths associated with the imaged wafer edge for determining a wafer edge shift distance.

According to an example embodiment, the following nonlimiting ranges of dimensional values are provided in the table below.

| | |
|---|---|
| WDia (wafer diameter) | from about 2 inches to about 12 |
| | inches |
| WSRSpeed(wafer/stage | from about 0.1 rpm to about 100 |
| rotation speed) | rpm |
| WSAlignAngXY1 | about 90 degrees |
| DSAlignAngXY2 | about 90 degrees |
| ESDAxisXZAng | about 90 degrees |
| ESDOffset(wafer edge | about ½ the width of the wafer |
| sensor offset) | |
| CAMOffset(camera | about ¼ of the diameter of the |
| offset) | wafer from the wafer center WCp |
| line scan width/length | from about 200 mm to about |
| | 400 mm |
| light source alignment | from about 20 mm to about |
| | 400 mm from the center of the |
| | line scan line |
| WSDist(wafer shift | from about −20 mm to about +20 |
| distance) | mm in X direction |
| feature/defect detection | about 5.5 um/pixel |
| size | |

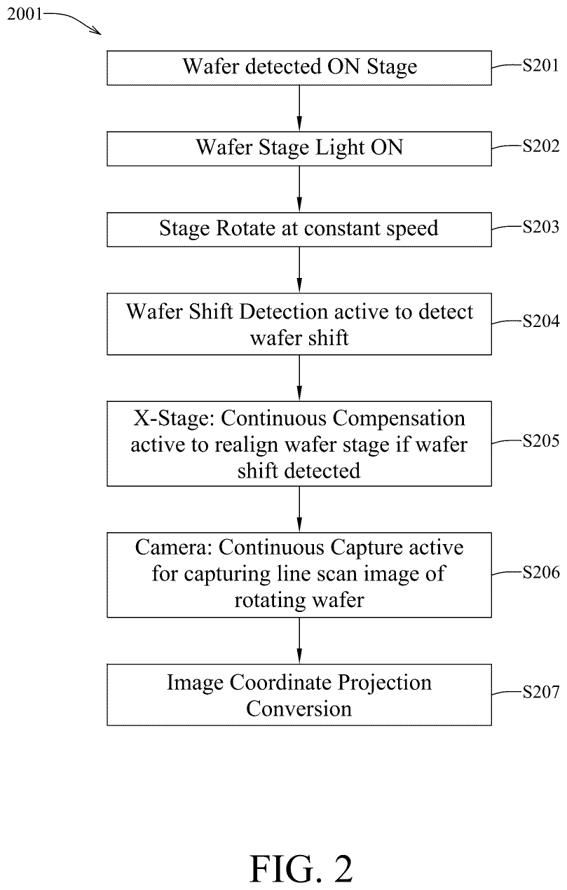

With reference to FIG. 2, shown is a flow chart of a semiconductor process/wafer imaging and/or inspection method according to an example embodiment of this disclosure (Embodiment 2; 2001), the method including the use of a single camera to radially image a wafer rotating at a constant speed where wafer shift is monitored and compensated for by laterally and linearly moving a wafer stage to realign the wafer relative to the camera.

At step S201, the process detects a wafer 40 is ON the rotatable wafer stage 114.

At step S202, the process turns the wafer stage light 120 ON.

At step S203, the process rotates the wafer stage 114 at a constant rotational speed.

At step S204, the wafer shift detection sensor 150 is controlled to be active to detect any wafer shift.

At step S205, an X directional stage 111 control system continuously compensates for any wafer edge shift detected to realign the wafer stage 114 if wafer shift is detected.

At step S206, a camera 130 continuously captures radial line scan images of the loaded rotating wafer.

At step S207, the captured radial line scan images are processed to map/coordinate/convert to one or both of a compiled line scan image and 2D area scan image of the wafer surface for inspection for features, such as defects.

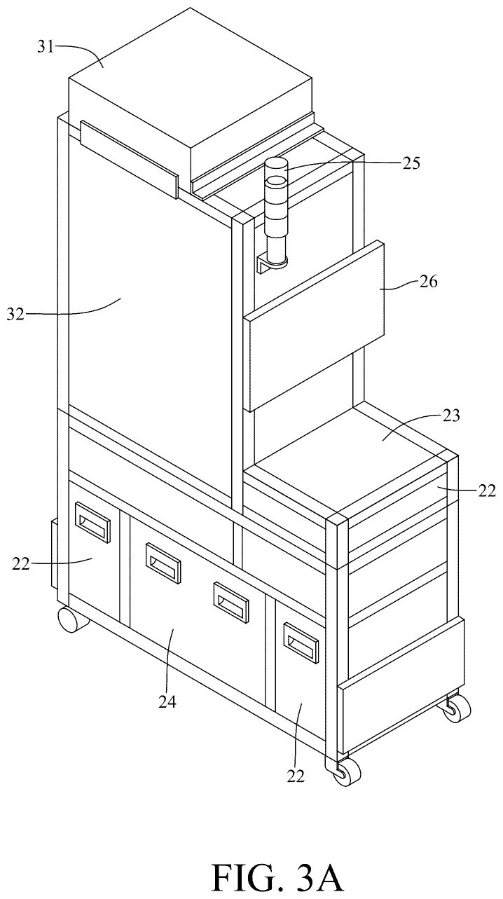

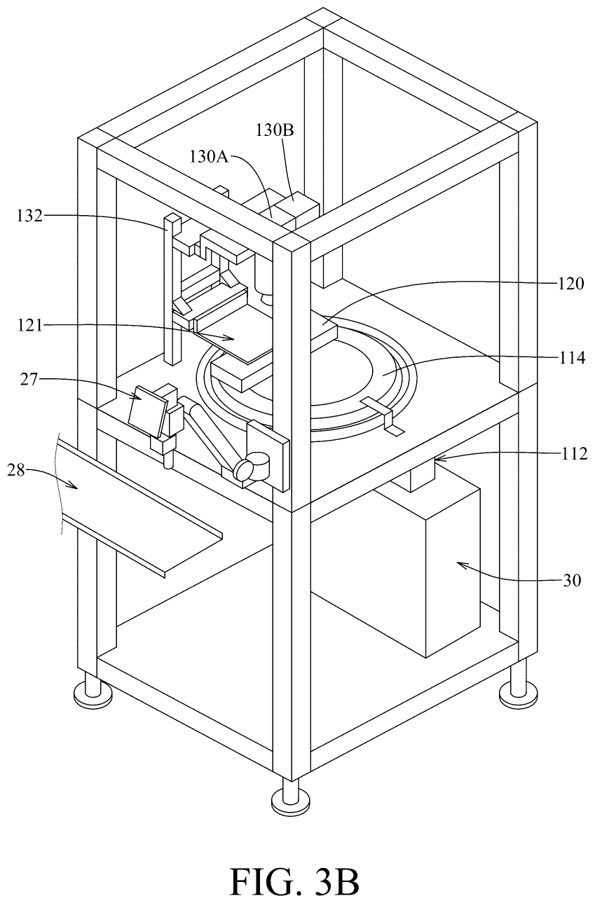

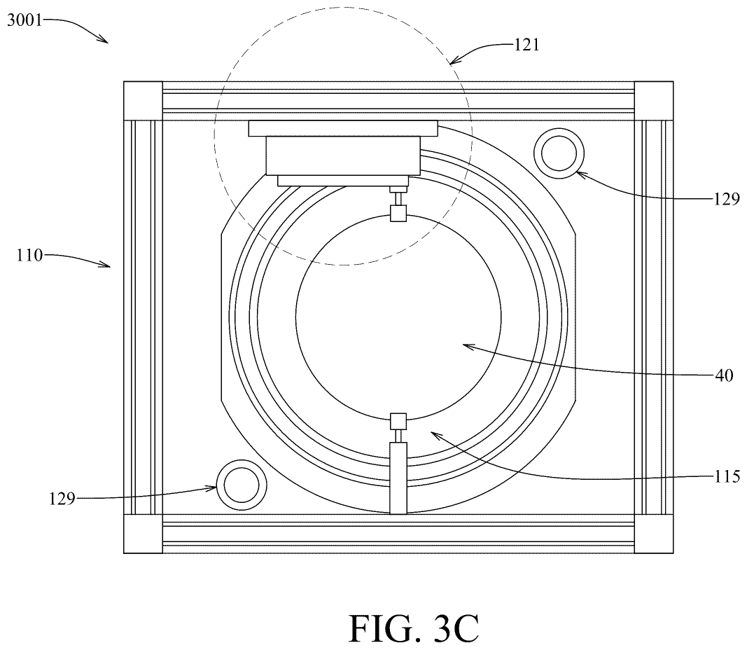

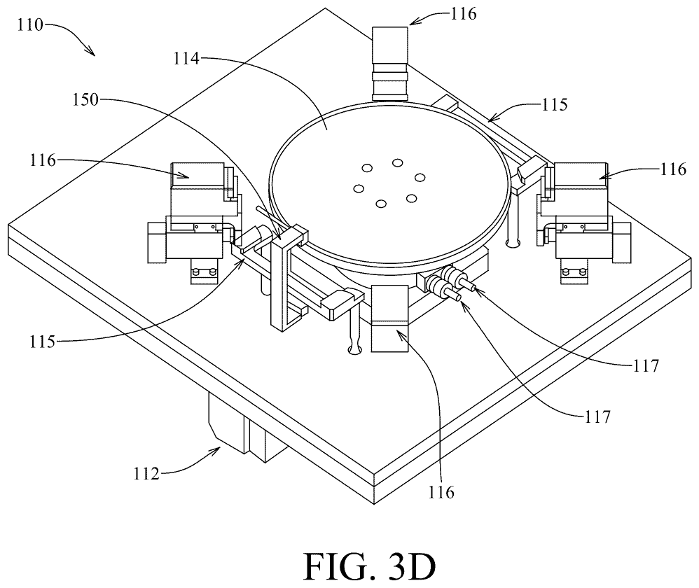

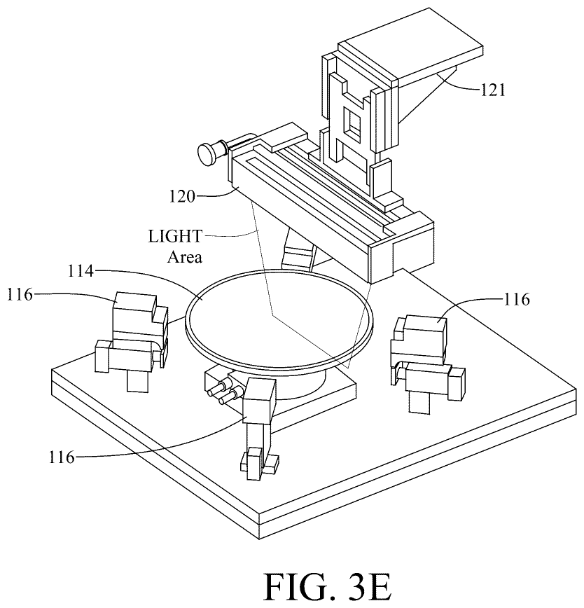

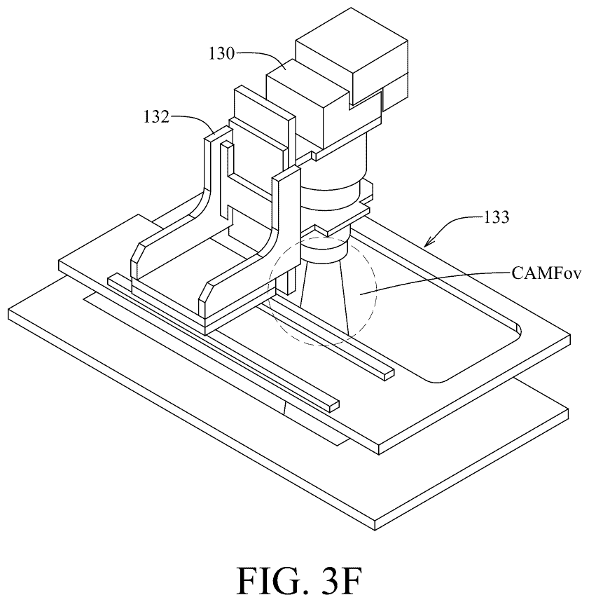

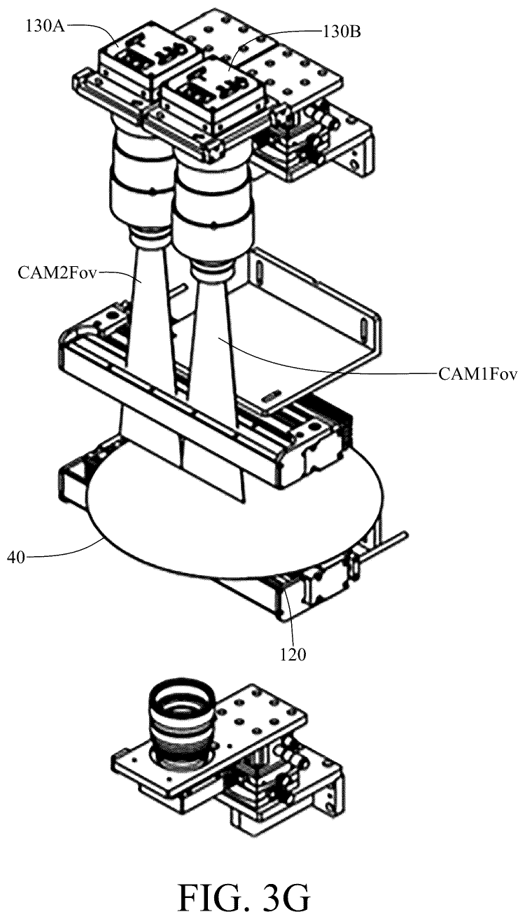

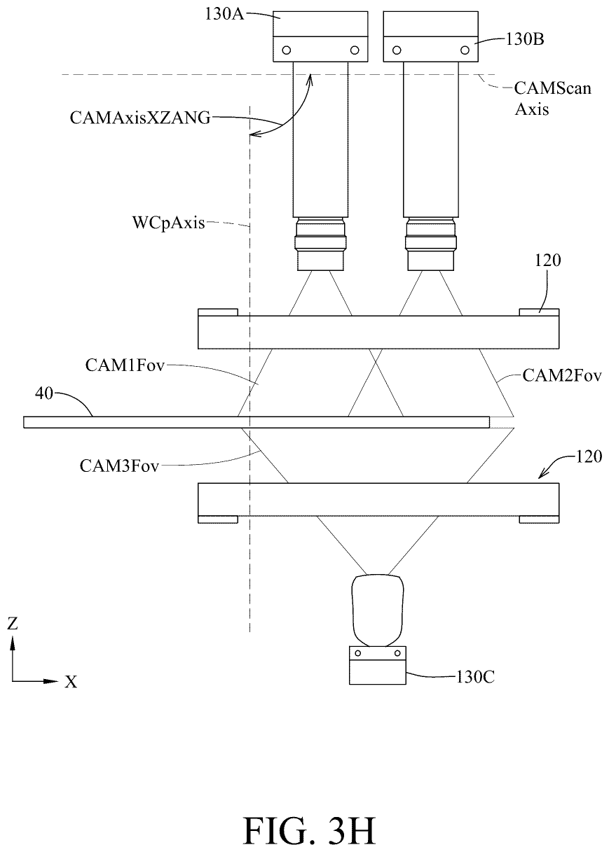

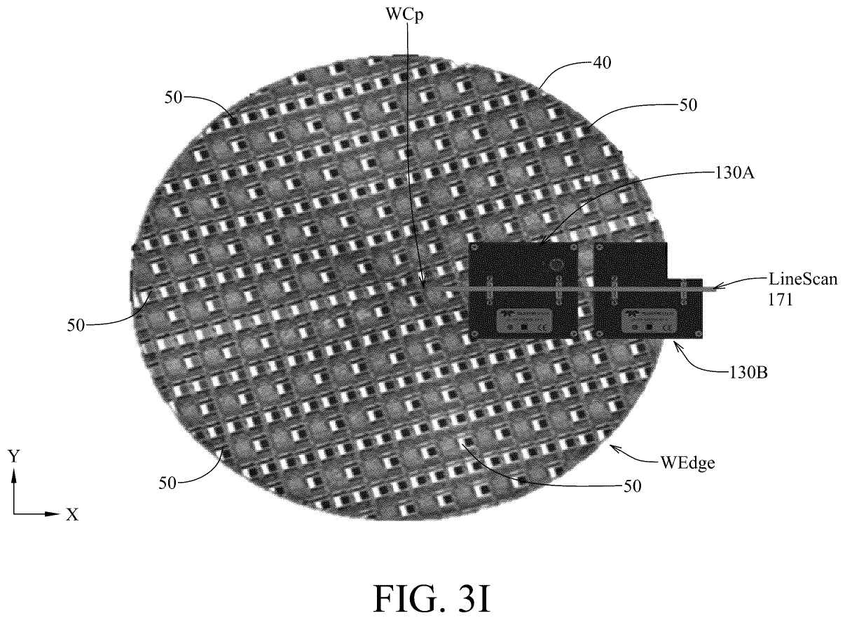

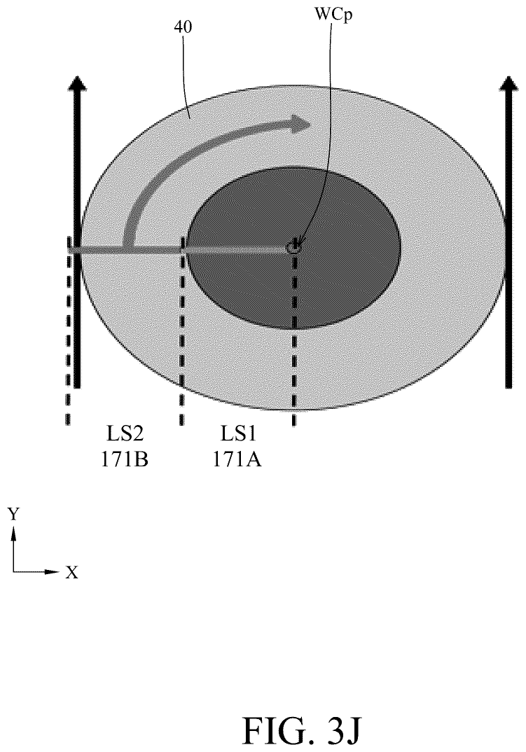

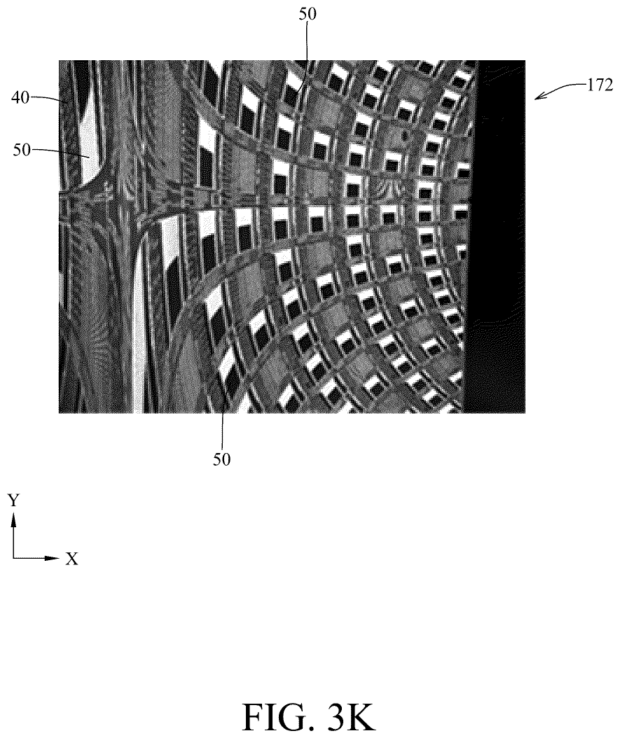

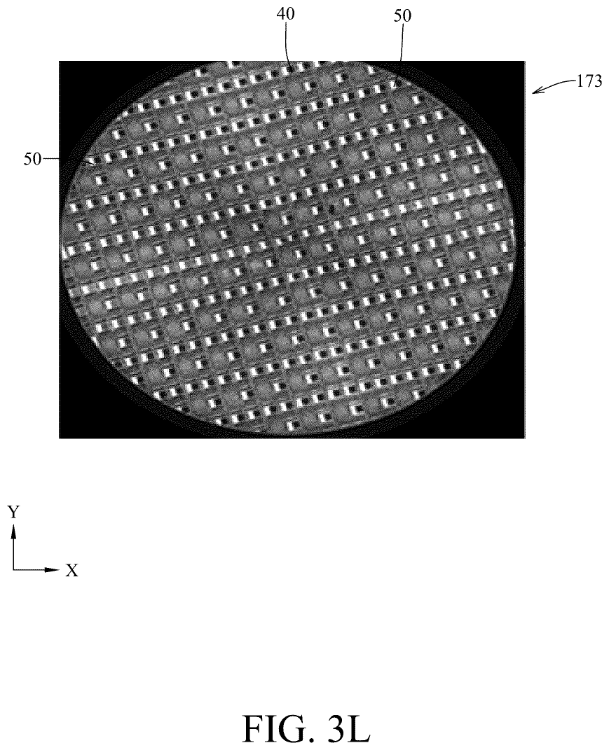

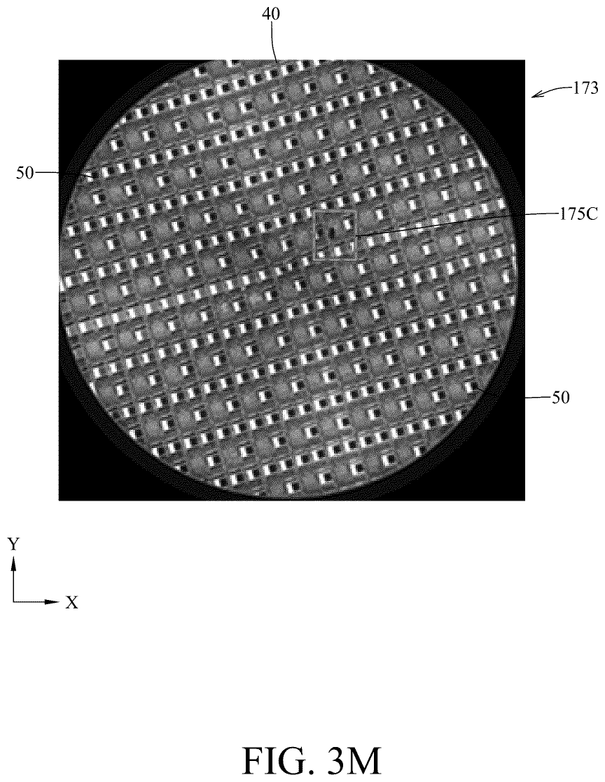

With reference to FIGS. 3A-3M, shown are various views of another semiconductor process/wafer imaging and/or inspection apparatus according to an example embodiment of this disclosure (Embodiment 3; 3001), the semiconductor process/wafer imaging and/or inspection apparatus including a rotatable wafer platform assembly 110, first and second radial scanning cameras 130A and 130B, e.g. line scanning cameras, and a bar light 120 mounted above a wafer to be rotatably imaged.

FIGS. 3A and 3B are perspective views of the semiconductor process/wafer imaging and/or inspection apparatus according to an example embodiment of this disclosure (Embodiment 3; 3001), the semiconductor process/wafer imaging and/or inspection apparatus including a rotatable wafer platform 114, first and second radial scanning cameras 130A and 130B, e.g. line scanning cameras, and a bar light 120 mounted above a wafer (not shown) to be rotatably imaged. Other components and features of the embodiment shown include an example wheeled housing with semiconductor processing components 22, load port 23, electronics housing space 24, indicator lights 25, display 26, display/computer mount 27, keyboard platform 28, computer 30, blower 31 and housing space for wafer inspection components 32.

With reference to FIG. 3C, shown is a detailed partial view of a wafer stage platform/apparatus/assembly/module 110 according to an example embodiment of this disclosure. The wafer stage platform/apparatus/assembly/module 110 includes cable through holes 129, light source holder/mount 121, wafer holders 115 and a wafer 40 held by the wafer holders 115.

With reference to FIG. 3D, shown is detailed perspective view of a wafer stage platform/apparatus/assembly/module 110 according to an example embodiment of this disclosure. The wafer stage platform/apparatus/assembly/module 110 includes a X directional motor 112 (e.g., hollow axis motor), a rotatable wafer stage 114, wafer present sensors 116, wafer holders 115, vacuum tubes 117 and a wafer edge detector 150.

With reference to FIGS. 3E and 3F, shown are other detailed perspective views of a wafer stage and camera arrangement according to an example embodiment of this disclosure, including the mounting of a single camera relative to a rotatable wafer stage, however the illustrated arrangement and components can also be applied to a double camera arrangement (Embodiment 3). These figures specifically illustrate the light source 120 illumination area LIGHTArea and camera 130 FOV CAMFov, as well as a mounting arrangement that includes a light source mount 121, camera vertical support 132, and camera horizontal support 133.

With reference to FIGS. 3G and 3H, FIG. 3G is an exploded view and FIG. 3H is a front view of a semiconductor process/wafer imaging and/or inspection apparatus according to an example embodiment of this disclosure, the semiconductor process/wafer imaging and/or inspection apparatus including a rotatable wafer platform (not shown), first and second radial scanning cameras 130A and 130B, e.g. line scanning cameras, for imaging a top side of a wafer, a third radial scanning camera 130C for imaging a bottom side of the wafer, and a bar light 12 mounted above and below a wafer to be rotatably imaged. The FOVs of the cameras 130A, 130B and 130C are shown as CAM1Fov, CAM2Fov and CAM3Fov, respectively. Camera scan axis CAMScanAxis and camera alignment axis angle CAMAxisXZAng show the relative alignment of the cameras.

With reference to FIG. 3I, shown is a complete area scan image of a radially imaged wafer used for inspection of the imaged wafer dies 50 according to an example embodiment of this disclosure. The complete area scan image was generated from a plurality of radial line scans 171 captured from a first camera 130A and a second camera 130B which are aligned to capture a radial image extending from the center of the wafer WCp to the wafer edge WEdge.

With reference to FIGS. 3J, 3K, 3L and 3M, FIG. 3J shows a diagram of the line scan areas 171A LS1 and 171B LS2 which are associated with respective line scan cameras 130A and 130B used to capture a complete radial image of a wafer according to an example embodiment of this disclosure. FIG. 3K shows a portion 172 of an accumulated line scan LS1 image acquired while the wafer and wafer stage are rotated at a constant speed, prior to processing the acquired radial images to generate an actual area image of the wafer which includes a physical shape scaled and/or proportional to the wafer. FIG. 3L shows a complete wafer image 173 generated by further processing of the captured radial images, e.g., FIG. 3K, where the line pixels are rotated by the angular position of the stage platform where each of the radial line pixels were captured. i.e., R-theta angle calculation. FIG. 3M shows another complete wafer image 173 generated by further processing of the captured radial images, e.g., FIG. 3K, where the line pixels are rotated by the angular position of the stage platform where each of the radial line pixels were captured, and an inspection process which detects a wafer feature 175C, e.g., defect, within the image.

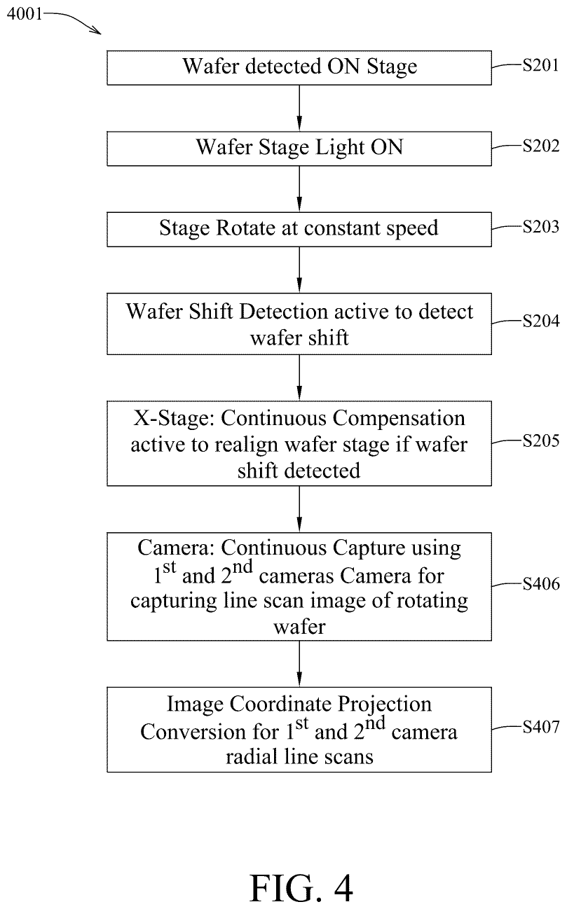

With reference to FIG. 4, shown is a flow chart of a semiconductor process/wafer imaging and/or inspection method according to an example embodiment of this disclosure (Embodiment 4; 4001), the method includes the use of a first 130A and second camera 130B to radially image a wafer 40 rotating at a constant speed where wafer shift is monitored and compensated for by laterally moving a wafer stage to realign the wafer with the cameras.

At step S201, the process detects a wafer 40 is ON the rotatable wafer stage 114.

At step S202, the process turns the wafer stage light 120 ON.

At step S203, the process rotates the wafer stage 114 at a constant rotational speed.

At step S204, the wafer shift detection sensor 150 is controlled to be active to detect any wafer shift.

At step S205, an X directional stage 111 control system continuously compensates for any wafer edge shift detected to realign the wafer stage 114 with cameras 130A and 130B if a wafer shift is detected.

At step S406, cameras 130A and 130B continuously capture radial line scan images of the loaded rotating wafer.

At step S407, the captured radial line scan images are processed to map/coordinate/convert to one or both of a compiled line scan image and 2D area scan image of the wafer surface for inspection for features, such as defects.

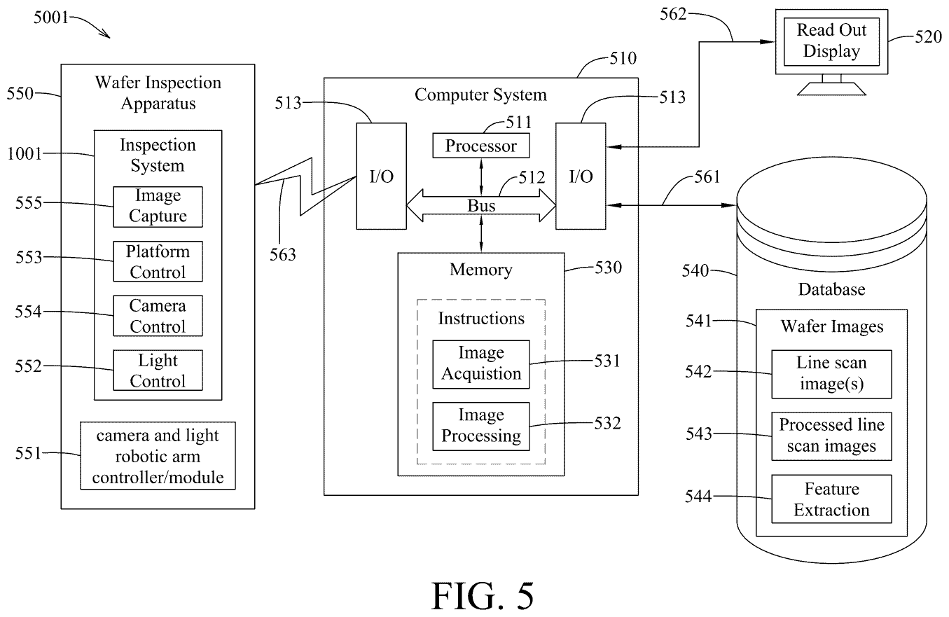

With reference to FIG. 5, shown is a block diagram of a semiconductor process/wafer imaging and/or inspection system according to another example embodiment of this disclosure (Embodiment 5; 5001).

As shown in FIG. 5, the wafer imaging and/or inspection platform system includes a computer system 510 in communication with a plurality of different devices, such as a wafer inspection/apparatus/device/tool 550, which includes a rotatable image processing apparatus/system to radially image/inspect a wafer surface as described herein 1001; 5001 including an image capture component 555, a wafer stage platform control component 553, a camera control component 544, a light control component 552 and a camera and light robotic arm controller/module 551.

The various components of the computer system 510 may be connected by a data/control bus 512. The processor of the computer system is in communication with an associated database 540 via a communications link 561. A suitable communications link 561 may include, for example, a switched telephone network, a wireless radio communications network, infrared, optical, or other suitable wired or wireless data communications. The database 540 is capable of implementation on components of the computer system 510, e.g., stored in local memory, i.e., on hard drives, virtual drives, or the like, or on remote memory accessible to the computer system.

The associated database is representative of any organized collections of data for use in acquiring and processing images 541 of a wafer as described herein, including but not limited to, line scan images 542, processed line scan images 543 and feature extraction/identification data which may include machine learning (ML) training data sets, etc. for ML classification. Implementation of the associated database is capable of occurring on any mass storage device(s), for example, magnetic storage drives, a hard disk drive, optical storage devices, flash memory devices, or a suitable combination thereof. The associated database may be implemented as a component of the computer system, e.g., resident in memory, or the like. In one embodiment, the associated database may include data corresponding to, for example and without limitation, production scheduling, wafer positioning, process chamber information (e.g., type, position, status, etc.), optical critical dimension (OCD) information, learning algorithms, graphical user interfaces, and the like.

As shown in FIG. 5, the computer system 510 may include one or more input/output (I/O) interface devices 513 for communicating with external devices. The I/O interface 513 may communicate, via communications link 562, with one or more of a display device 520, for displaying information, such images of a wafer for inspection, pass/fail status, etc. and a user input device, such as a keyboard or touch or writable screen, for inputting text, and/or a cursor control device, such as mouse, trackball, or the like, for communicating user input information and command selections to the processor. The I/O interface 513 may communicate with external devices such as wafer inspection apparatus 550, other semiconductor manufacturing systems, and the like, via a suitable communications links 563. The communications links 563 may comprise any wired or wireless communications means known in the art including, for example and without limitation, 802.11(x), the public-switch telephone network, VLAN, the Internet, Bluetooth, Ethernet, cellular, or any other wired or wireless hardware, software, and/or protocols enabling electronic communication between devices.

It will be appreciated that the computer system 510 illustrated in FIG. 5 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 5 as a networked set of components, the computer system 510 is capable of implementation on a stand-alone device adapted to interact with the wafer inspection apparatus 550 described herein.

The computer system 510 may include one or more of a computer server, workstation, personal computer, cellular telephone, tablet computer, pager, combination thereof, or other computing device capable of executing instructions for performing the exemplary method.

According to one example embodiment, the computer system 510 includes hardware, software, and/or any suitable combination thereof, configured to interact with an associated user, a networked device, networked storage, remote devices, or the like.

The memory 530 illustrated in FIG. 5 as a component of the computer system 510 may represent any type of non-transitory computer readable medium such as random access memory (RAM), read only memory (ROM), magnetic disk or tape, optical disk, flash memory, or holographic memory. In one embodiment, the memory 530 comprises a combination of random access memory and read only memory. In some embodiments, the processor 511 and memory may be combined in a single chip. The network interface(s) allow the computer to communicate with other devices via a computer network, and may comprise a modulator/demodulator (MODEM). Memory 530 may store data processed in the method as well as the instructions for performing the exemplary methods described herein.

The digital processor 511 can be variously embodied, such as by a single core processor, a dual core processor (or more generally by a multiple core processor), a digital processor and cooperating math coprocessor, a digital controller, or the like. The digital processor 511, in addition to controlling the operation of the computer system executes instructions stored in memory for performing the method set forth hereinafter.

As shown in FIG. 5, the instructions stored in memory 530 may include computer executable instructions for image acquisition 531 and image processing of captured wafer images 532. In addition, an analytical machine learning (ML) training/classifier component (not shown) configured to produce an analytical machine learning model for use in an imaging and inspection system as previously described herein. The analytical ML training component may utilize one or more additional components, including, for example and without limitation, an ML feature extraction component, an ML-OCD predictor component, and one or more machine learning algorithms. In accordance with one embodiment, machine learning algorithm includes, for example and without limitation, the lasso linear regression algorithm and method, however any suitable type of ML algorithm having one or more “feature selection” function would be applicable for this disclosure. (e.g.: neural network, fast Fourier Transform (FFT), principal component analysis (PCA), support vector machine (SVM), Gaussian processing, ordinary least squares regression (OLSR), linear regression, logistic regression, stepwise regression, multivariate adaptive regression splines (MARS), locally estimated scatterplot smoothing (LOESS), partial least squares regression (PLSR), or the like. An analytical ML training component of the instructions stored in memory may also include a machine-learning feature extraction component configured to extract one or more features from a training set. According to some embodiments, the features may correspond to characteristics, properties and/or attributes extracted by statistical or machine learning functions from raw data. The extracted features may then be processed utilizing one or more feature functions, i.e., mathematical functions used for extracting the aforementioned features from raw data, such as, for example and without limitation, dimension reduction functions.

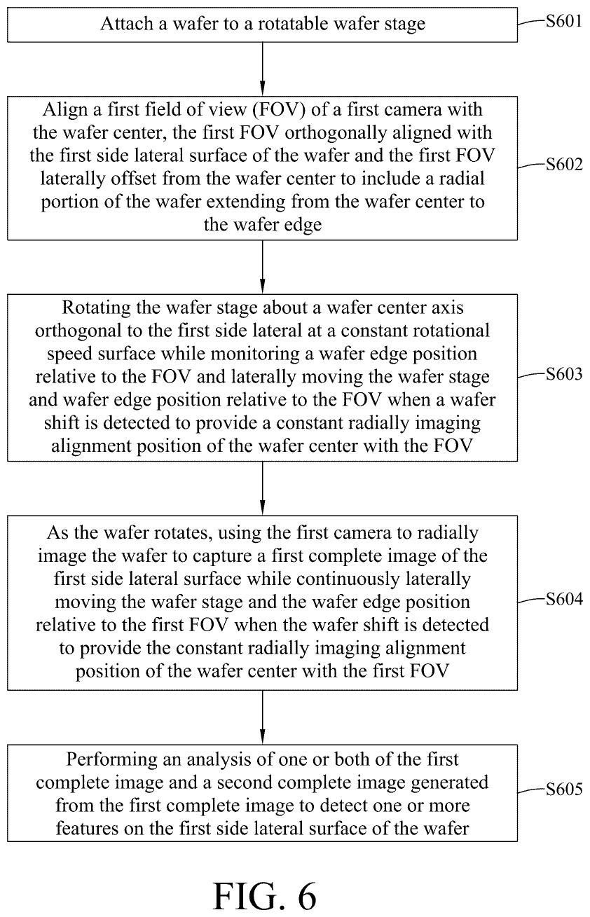

With reference to FIG. 6, shown is flow chart of another semiconductor process/wafer imaging and/or inspection method according to an example embodiment of this disclosure.

At step S601, the process attaches a wafer to a rotatable wafer stage.

At step S602, the process aligns a first field of view (FOV) of a first camera with the wafer center, the first FOV orthogonally aligned with the first side lateral surface of the wafer and the first FOV laterally offset from the wafer center to include a radial portion of the wafer extending from the wafer center to the wafer edge.

At step S603, the process rotates the wafer stage about a wafer center axis orthogonal to the first side lateral at a constant rotational speed surface while monitoring a wafer edge position relative to the FOV and laterally moving the wafer stage and wafer edge position relative to the FOV when a wafer shift is detected to provide a constant radially imaging alignment position of the wafer center with the FOV.

At step S604, as the wafer rotates, the process uses the first camera to radially image the wafer to capture a first complete image of the first side lateral surface while continuously laterally moving the wafer stage and the wafer edge position relative to the first FOV when the wafer shift is detected to provide the constant radially imaging alignment position of the wafer center with the first FOV.

At step S605, the process performs an analysis of one or both of the first complete image and a second complete image generated from the first complete image to detect one or more features on the first side lateral surface of the wafer.

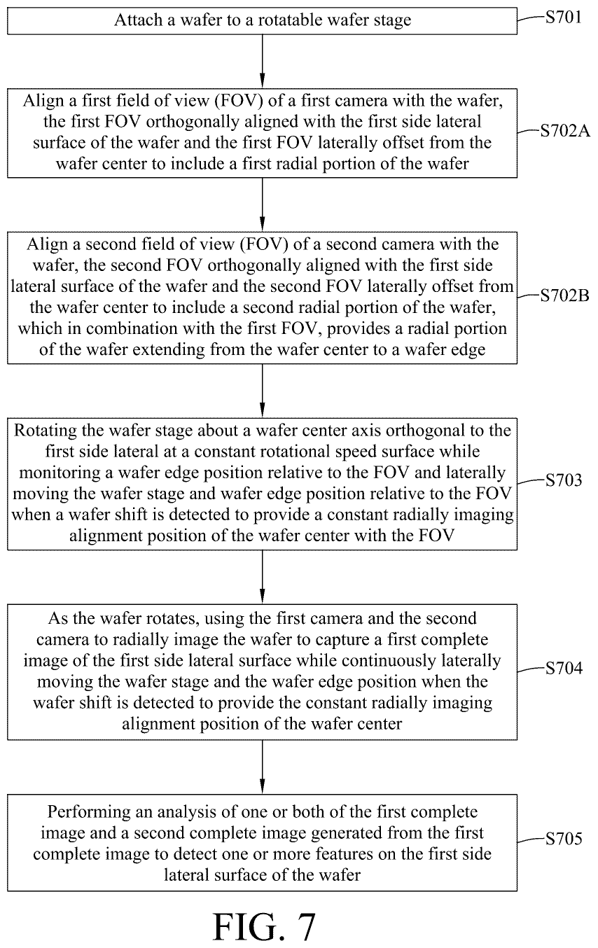

With reference to FIG. 7, shown is a flow chart of another semiconductor process/wafer imaging and/or inspection method according to an example embodiment of this disclosure.

At step S701, the process attaches a wafer to a rotatable wafer stage.

At step S702A, the process aligns a first field of view (FOV) of a first camera with the wafer, the first FOV orthogonally aligned with the first side lateral surface of the wafer and the first FOV laterally offset from the wafer center to include a first radial portion of the wafer.

At step S702B, the process aligns a second field of view (FOV) of a second camera with the wafer, the second FOV orthogonally aligned with the first side lateral surface of the wafer and the second FOV laterally offset from the wafer center to include a second radial portion of the wafer, which in combination with the first FOV, provides a radial portion of the wafer extending from the wafer center to a wafer edge.

At step S703, the process rotates the wafer stage about a wafer center axis orthogonal to the first side lateral at a constant rotational speed surface while monitoring a wafer edge position relative to the FOV and laterally moving the wafer stage and wafer edge position relative to the FOV when a wafer shift is detected to provide a constant radially imaging alignment position of the wafer center with the FOV.

At step S704, as the wafer rotates, the process uses the first camera and the second camera to radially image the wafer to capture a first complete image of the first side lateral surface while continuously laterally moving the wafer stage and the wafer edge position when the wafer shift is detected to provide the constant radially imaging alignment position of the wafer center.

At step S705, the process performs an analysis of one or both of the first complete image and a second complete image generated from the first complete image to detect one or more features on the first side lateral surface of the wafer.

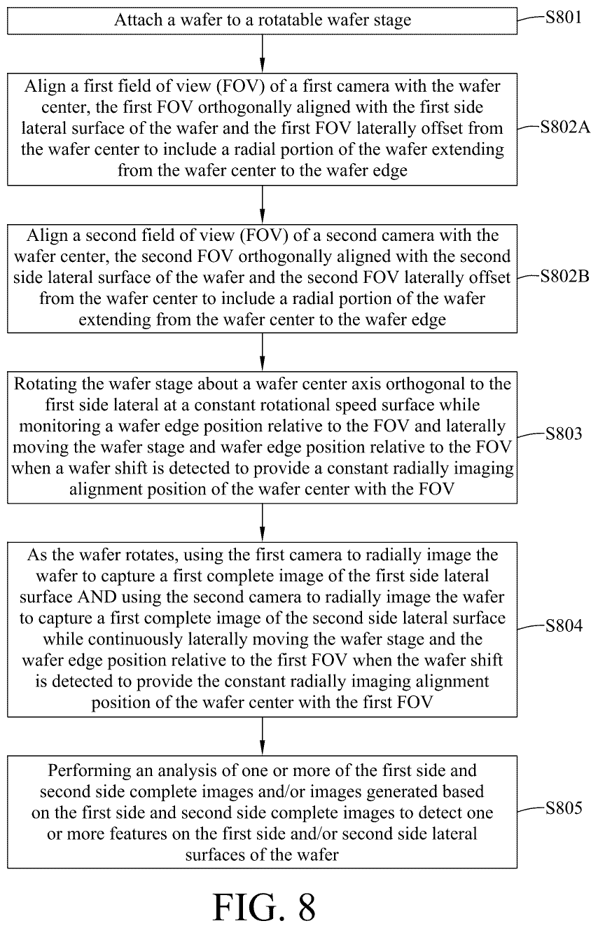

With reference to FIG. 8, shown is flow chart of another semiconductor process/wafer imaging and/or inspection method according to an example embodiment of this disclosure.

At step S801, the process attaches a wafer to a rotatable wafer stage.

At step S802A, the process aligns a first field of view (FOV) of a first camera with the wafer center, the first FOV orthogonally aligned with the first side lateral surface of the wafer and the first FOV laterally offset from the wafer center to include a radial portion of the wafer extending from the wafer center to the wafer edge.

At step S802B, the process aligns a second field of view (FOV) of a second camera with the wafer center, the second FOV orthogonally aligned with the second side lateral surface of the wafer and the second FOV laterally offset from the wafer center to include a radial portion of the wafer extending from the wafer center to the wafer edge.

At step S803, the process rotating the wafer stage about a wafer center axis orthogonal to the first side lateral at a constant rotational speed surface while monitoring a wafer edge position relative to the FOV and laterally moving the wafer stage and wafer edge position relative to the FOV when a wafer shift is detected to provide a constant radially imaging alignment position of the wafer center with the FOV.

At step S804, as the wafer rotates, the process uses the first camera to radially image the wafer to capture a first complete image of the first side lateral surface AND using the second camera to radially image the wafer to capture a first complete image of the second side lateral surface while continuously laterally moving the wafer stage and the wafer edge position relative to the first FOV when the wafer shift is detected to provide the constant radially imaging alignment position of the wafer center with the first FOV.

At step S805, the process performs an analysis of one or more of the first side and second side complete images and/or images generated based on the first side and second side complete images to detect one or more features on the first side and/or second side lateral surfaces of the wafer.

Based on the above discussions, it can be seen that the present disclosure offers advantages. It is understood, however, that other embodiments may offer additional advantages, and not all advantages are necessarily disclosed herein, and that no particular advantage is required for all embodiments. One advantage is that the disclosed wafer imaging and inspection methods, apparatus and systems require provide a reduced area requirement for scanning a wafer and generating an image of the wafer, thereby reducing the physical footprint required for incorporating a wafer image scanning system into a semiconductor manufacturing process thereby enabling the inspection of semiconductor wafers and dies at various locations throughout the semiconductor process for an improved quality assurance process.

In the following, some further embodiments are described.

In a nonlimiting illustrative embodiment, semiconductor processing method comprising: attaching a wafer to a rotatable wafer stage, the wafer having a circular shape with a wafer center, a wafer edge located at a wafer perimeter radially offset from the wafer center, a first side lateral surface and a second side lateral surface opposite the first side lateral surface; aligning a first field of view (FOV) of a first camera with the wafer center, the first FOV orthogonally aligned with the first side lateral surface of the wafer and the first FOV laterally offset from the wafer center to include a radial portion of the wafer extending from the wafer center to the wafer edge; rotating the wafer stage and wafer attached thereto about a wafer center axis orthogonal to the first side lateral surface; as the wafer rotates, using the first camera to radially image the wafer to capture a first complete image of the first side lateral surface while continuously laterally moving the wafer stage and a wafer edge position relative to the first FOV; and performing an analysis of one or both of the first complete image and a second complete image generated from the first complete image to detect one or more features on the first side lateral surface of the wafer.

In a nonlimiting illustrative embodiment, a semiconductor processing method comprising: attaching a wafer to a rotatable wafer stage, the wafer having a circular shape with a wafer center, a wafer edge located at a wafer perimeter radially offset from the wafer center, a first side lateral surface and a second side lateral surface opposite the first side lateral surface; aligning a first field of view (FOV) of a first camera with the wafer center, the first FOV orthogonally aligned with the first side lateral surface of the wafer and the first FOV laterally offset from the wafer center to include a radial portion of the wafer extending from the wafer center to the wafer edge; rotating the wafer stage and wafer attached thereto about a wafer center axis orthogonal to the first side lateral surface, the wafer stage and wafer attached thereto rotated at a constant rotational speed while monitoring a wafer edge position relative to the FOV and laterally moving the wafer stage and wafer edge position relative to the FOV when a wafer shift is detected to provide a constant radially imaging alignment position of the wafer center with the FOV; as the wafer rotates, using the first camera to radially image the wafer to capture a first complete image of the first side lateral surface while continuously laterally moving the wafer stage and the wafer edge position relative to the first FOV when the wafer shift is detected to provide the constant radially imaging alignment position of the wafer center with the first FOV; and performing an analysis of one or both of the first complete image and a second complete image generated from the first complete image to detect one or more features on the first side lateral surface of the wafer.

In another nonlimiting illustrative embodiment, a semiconductor processing apparatus comprising: a semiconductor processing apparatus comprising: a rotatable wafer stage and wafer holder operatively associated with attaching a wafer thereto, the rotatable wafer stage laterally translatable along an x axis direction associated with the wafer stage to laterally move the wafer stage as it rotates, the x axis direction orthogonal to a wafer stage center axis that the wafer stage rotates about; a first camera with a first field of view (FOV) aligned orthogonally with a wafer center of the operatively associated wafer attached to the rotatable wafer stage; a wafer edge detector monitoring a wafer edge position relative to the first FOV and detecting a wafer shift along the x-axis direction; and a controller operatively associated with the rotatable wafer stage, the first camera and the wafer edge detector; the controller configured to execute instructions to: align the first field of view (FOV) of the first camera with a wafer center of a wafer attached to the rotatable wafer stage, the first FOV orthogonally aligned with a first side lateral surface of the wafer and the first FOV laterally offset from the wafer center to include a radial portion of the wafer extending from the wafer center to a wafer edge; rotate the wafer stage and wafer attached thereto about a wafer center axis orthogonal to the first side lateral surface; as the wafer rotates, using the first camera to radially image the wafer to capture a first complete image of the first side lateral surface while continuously laterally moving the wafer stage and a wafer edge position relative to the first FOV; and performing an analysis of one or both of the first complete image and a second complete image generated from the first complete image to detect one or more features on the first side lateral surface of the wafer.

In another nonlimiting illustrative embodiment, a semiconductor processing apparatus comprising: a rotatable wafer stage and wafer holder operatively associated with attaching a wafer thereto, the rotatable wafer stage laterally translatable along an x axis direction associated with the wafer stage to laterally move the wafer stage as it rotates, the x axis direction orthogonal to a wafer stage center axis that the wafer stage rotates about; a first camera with a first field of view (FOV) aligned orthogonally with a wafer center of the operatively associated wafer attached to the rotatable wafer stage; a wafer edge detector monitoring a wafer edge position relative to the first FOV and detecting a wafer shift along the x-axis direction; and a controller operatively associated with the rotatable wafer stage, the first camera and the wafer edge detector; the controller configured to execute instructions to: align the first field of view (FOV) of the first camera with a wafer center of a wafer attached to the rotatable wafer stage, the first FOV orthogonally aligned with a first side lateral surface of the wafer and the first FOV laterally offset from the wafer center to include a radial portion of the wafer extending from the wafer center to a wafer edge; rotate the wafer stage and wafer attached thereto about a wafer center axis orthogonal to the first side lateral surface, the wafer stage and wafer attached thereto rotated at a constant rotational speed while monitoring the wafer edge position relative to the FOV and laterally moving the wafer stage and the wafer edge position relative to the FOV when the wafer shift is detected to provide a constant radially imaging alignment position of the wafer center with the FOV; as the wafer rotates, using the first camera to radially image the wafer to capture a first complete image of the first side lateral surface while continuously laterally moving the wafer stage and the wafer edge position relative to the first FOV when the wafer shift is detected to provide the constant radially imaging alignment position of the wafer center with the first FOV; and performing an analysis of one or both of the first complete image and a second complete image generated from the first complete image to detect one or more features on the first side lateral surface of the wafer.

In another nonlimiting illustrative embodiment, a semiconductor processing method comprising: a semiconductor processing method comprising: attaching a wafer to a rotatable wafer stage, the wafer having a circular shape with a wafer center, a wafer edge located at a wafer perimeter radially offset from the wafer center, a first side lateral surface and a second side lateral surface opposite the first side lateral surface; aligning a first field of view (FOV) of a first camera with the wafer, the first FOV orthogonally aligned with the first side lateral surface of the wafer and the first FOV laterally offset from the wafer center to include a first radial portion of the wafer; aligning a second field of view (FOV) of a second camera with the wafer, the second FOV orthogonally aligned with the first side lateral surface of the wafer and the second FOV laterally offset from the wafer center to include a second radial portion of the wafer, which in combination with the first FOV, provides a radial portion of the wafer extending from the wafer center to a wafer edge; rotating the wafer stage and wafer attached thereto about a wafer center axis orthogonal to the first side lateral surface; as the wafer rotates, using the first camera and the second camera to radially image the wafer to capture a first complete image of the first side lateral surface while continuously laterally moving the wafer stage and a wafer edge position when a wafer shift is detected to provide the constant radially imaging alignment position of the wafer center; and performing an analysis of one or both of the first complete image and a second complete image generated from the first complete image to detect one or more features on the first side lateral surface of the wafer.

In another nonlimiting illustrative embodiment, a semiconductor processing method comprising: attaching a wafer to a rotatable wafer stage, the wafer having a circular shape with a wafer center, a wafer edge located at a wafer perimeter radially offset from the wafer center, a first side lateral surface and a second side lateral surface opposite the first side lateral surface; aligning a first field of view (FOV) of a first camera with the wafer, the first FOV orthogonally aligned with the first side lateral surface of the wafer and the first FOV laterally offset from the wafer center to include a first radial portion of the wafer; aligning a second field of view (FOV) of a second camera with the wafer, the second FOV orthogonally aligned with the first side lateral surface of the wafer and the second FOV laterally offset from the wafer center to include a second radial portion of the wafer, which in combination with the first FOV, provides a radial portion of the wafer extending from the wafer center to a wafer edge; rotating the wafer stage and wafer attached thereto about a wafer center axis orthogonal to the first side lateral surface, the wafer stage and wafer attached thereto rotated at a constant rotational speed while monitoring a wafer edge position and laterally moving the wafer stage and wafer edge position when a wafer shift is detected to provide a constant radially imaging alignment position of the wafer center; as the wafer rotates, using the first camera and the second camera to radially image the wafer to capture a first complete image of the first side lateral surface while continuously laterally moving the wafer stage and the wafer edge position when the wafer shift is detected to provide the constant radially imaging alignment position of the wafer center; and performing an analysis of one or both of the first complete image and a second complete image generated from the first complete image to detect one or more features on the first side lateral surface of the wafer.

In another nonlimiting illustrative embodiment, a semiconductor processing apparatus comprising: a rotatable wafer stage and wafer holder operatively associated with attaching a wafer thereto, the rotatable wafer stage laterally translatable along an x axis direction associated with the wafer stage to laterally move the wafer stage as it rotates, the x axis direction orthogonal to a wafer stage center axis that the wafer stage rotates about; a first camera with a first field of view (FOV) and a second camera with a second FOV; a wafer edge detector monitoring a wafer edge position relative to the first FOV and detecting a wafer shift along the x-axis direction; and a controller operatively associated with the rotatable wafer stage, the first camera, the second camera and the wafer edge detector; the controller configured to execute instructions to: align a combination of the first field of view (FOV) of the first camera and second FOV of the second camera with a wafer attached to the rotatable wafer stage, the first FOV and second FOV orthogonally aligned with a first side lateral surface of the wafer and the combination first FOV and second FOV laterally offset from the wafer center to include a radial portion of the wafer extending from the wafer center to a wafer edge; rotate the wafer stage and wafer attached thereto about a wafer center axis orthogonal to the first side lateral surface, the wafer stage and wafer attached thereto rotated at a constant rotational speed while monitoring the wafer edge position relative to the FOV and laterally moving the wafer stage and the wafer edge position relative to the FOV when the wafer shift is detected to provide a constant radially imaging alignment position of the wafer center with the FOV; as the wafer rotates, using the first camera and second camera to radially image the wafer to capture a first complete image of the first side lateral surface while continuously laterally moving the wafer stage and the wafer edge position relative to the combination first FOV and second FOV when the wafer shift is detected to provide the constant radially imaging alignment position of the wafer center with the first FOV; and performing an analysis of one or both of the first complete image and a second complete image generated from the first complete image to detect one or more features on the first side lateral surface of the wafer.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor processing method comprising:
attaching a wafer to a rotatable wafer stage, the wafer having a circular shape with a wafer center, a wafer edge located at a wafer perimeter radially offset from the wafer center, a first side lateral surface and a second side lateral surface opposite the first side lateral surface;
aligning a first field of view (FOV) of a first camera with the wafer center, the first FOV orthogonally aligned with the first side lateral surface of the wafer and the first FOV laterally offset from the wafer center to include a radial portion of the wafer extending from the wafer center to the wafer edge;
rotating the wafer stage and wafer attached thereto about a wafer center axis orthogonal to the first side lateral surface;
as the wafer rotates, using the first camera to radially image the wafer to capture a first complete image of the first side lateral surface while continuously laterally moving the wafer stage and a wafer edge position relative to the first FOV; and
performing an analysis of one or both of the first complete image and a second complete image generated from the first complete image to detect one or more features on the first side lateral surface of the wafer.

2. The method of claim 1, further comprising:
image processing the first complete image to generate the second complete image of the first side lateral surface, the first complete image including a plurality of radial line scan images of the first side lateral surface and the second complete image including a transformation of the plurality of radial line scan images of the first side lateral surface to an actual image representation of the first side lateral surface having a 2 dimensional shape scaled to an actual physical shape of the wafer placed on the rotating inspection table.

3. The method of claim 2, wherein the second complete image is generated by rotating the plurality of captured radial line scan images of the first side lateral surface at a plurality of respective rotational angles of the wafer stage associated with capturing each of the plurality of captured radial line scan images of the first side lateral surface.

4. The method of claim 1, further comprising:
using a second camera with a second FOV orthogonally aligned with the first side lateral surface of the wafer in combination with the first camera to capture a first complete image of the first side lateral surface, the first camera having a first offset from the wafer center to provide the first FOV including a first radial portion of the wafer and the second camera second having a second offset from the wafer center to provide the second FOV including a second radial portion of the wafer, wherein a combination of the first radial portion and the second radial portion provides the radial portion of the wafer extending from the wafer center to the wafer edge.

5. The method of claim 1, further comprising:
aligning a second field of view (FOV) of a second camera with the wafer center, the second FOV orthogonally aligned with the second side lateral surface of the wafer and the second FOV laterally offset from the wafer center to include a radial portion of the wafer extending from the wafer center to the wafer edge; and
as the wafer rotates, using the first camera to radially image the wafer to capture a first complete image of the first side lateral surface and using the second camera to radially image the wafer to capture a first complete image of the second side lateral surface while continuously laterally moving the wafer stage and the wafer edge position to provide the constant radially imaging alignment position of the wafer center with the first FOV and the second FOV.

6. The method of claim 1, wherein the first camera is a line scan camera and the method further comprises:
calibrating a plurality of line scan camera pixel locations to the first FOV radial portion of the wafer extending from the wafer center to the wafer edge.

7. The method of claim 1, further comprising:
the wafer stage and wafer attached thereto rotated at a constant rotational speed while monitoring the wafer edge position relative to the FOV and laterally moving the wafer stage and wafer edge position relative to the FOV when a wafer shift is detected to provide a constant radially imaging alignment position of the wafer center with the FOV; and
as the wafer rotates, using the first camera to radially image the wafer to capture a first complete image of the first side lateral surface while continuously laterally moving the wafer stage and the wafer edge position relative to the first FOV when the wafer shift is detected to provide the constant radially imaging alignment position of the wafer center with the first FOV.

8. The method of claim 7, further comprising:
using an encoder to control the rotational speed of the wafer stage and provide a plurality of respective rotational angles of the wafer stage associated with capturing a plurality of captured radial line scan images of the first side lateral surface.

9. The method of claim 1, further comprising:
aligning a second field of view (FOV) of a second camera with the wafer edge, the second FOV aligned with the wafer edge of the first side lateral surface of the wafer and the second camera capturing images of the wafer edge as the wafer rotates to monitor the wafer edge position and determining when the wafer shift has occurred.

10. The method of claim 1, wherein the wafer stage is laterally translated along an x axis direction associated with the wafer stage to continuously laterally moving the wafer stage and the wafer edge position relative to the first FOV when the wafer shift is detected, the x axis direction orthogonal to the wafer center axis.

11. A semiconductor processing apparatus comprising:
a rotatable wafer stage and wafer holder operatively associated with attaching a wafer thereto, the rotatable wafer stage laterally translatable along an x axis direction associated with the wafer stage to laterally move the wafer stage as it rotates, the x axis direction orthogonal to a wafer stage center axis that the wafer stage rotates about;
a first camera with a first field of view (FOV) aligned orthogonally with a wafer center of the operatively associated wafer attached to the rotatable wafer stage;
a wafer edge detector monitoring a wafer edge position relative to the first FOV and detecting a wafer shift along the x-axis direction; and
a controller operatively associated with the rotatable wafer stage, the first camera and the wafer edge detector; the controller configured to execute instructions to:
align the first field of view (FOV) of the first camera with a wafer center of a wafer attached to the rotatable wafer stage, the first FOV orthogonally aligned with a first side lateral surface of the wafer and the first FOV laterally offset from the wafer center to include a radial portion of the wafer extending from the wafer center to a wafer edge;
rotate the wafer stage and wafer attached thereto about a wafer center axis orthogonal to the first side lateral surface;
as the wafer rotates, using the first camera to radially image the wafer to capture a first complete image of the first side lateral surface while continuously laterally moving the wafer stage and a wafer edge position relative to the first FOV; and
performing an analysis of one or both of the first complete image and a second complete image generated from the first complete image to detect one or more features on the first side lateral surface of the wafer.

12. The apparatus of claim 11, further comprising:
the controller configured to execute instructions to:
image process the first complete image to generate the second complete image of the first side lateral surface, the first complete image including a plurality of radial line scan images of the first side lateral surface and the second complete image including a transformation of the plurality of radial line scan images of the first side lateral surface to an actual image representation of the first side lateral surface having a 2 dimensional shape scaled to an actual physical shape of the wafer placed on the rotatable wafer stage.

13. The apparatus of claim 12, wherein the second complete image is generated by rotating the plurality of captured radial line scan images of the first side lateral surface at a plurality of respective rotational angles of the wafer stage associated with capturing each of the plurality of captured radial line scan images of the first side lateral surface.

14. The apparatus of claim 11, further comprising:
the first camera having a first offset from the wafer center to provide the first FOV including a first radial portion of the wafer; and
a second camera with a second field of view (FOV), the second FOV orthogonally aligned with the first side lateral surface of the wafer and the second FOV laterally offset from the wafer center to include a second radial portion of the wafer, which in combination with the first FOV, provides the radial portion of the wafer extending from the wafer center to a wafer edge.

15. The apparatus of claim 11, wherein the first camera is a line scan camera and the controller is configured to execute instructions to:
calibrate a plurality of line scan camera pixel locations to the first FOV radial portion of the wafer extending from the wafer center to the wafer edge.

16. The apparatus of claim 11, further comprising:
the wafer stage and wafer attached thereto rotated at a constant rotational speed while monitoring the wafer edge position relative to the FOV and laterally moving the wafer stage and wafer edge position relative to the FOV when a wafer shift is detected to provide a constant radially imaging alignment position of the wafer center with the FOV; and
as the wafer rotates, using the first camera to radially image the wafer to capture a first complete image of the first side lateral surface while continuously laterally moving the wafer stage and the wafer edge position relative to the first FOV when the wafer shift is detected to provide the constant radially imaging alignment position of the wafer center with the first FOV; and
an encoder configured to control the rotational speed of the wafer stage and provide a plurality of respective rotational angles of the wafer stage associated with capturing a plurality of captured radial line scan images of the first side lateral surface.

17. The apparatus of claim 11, wherein the wafer edge detector includes a second camera with a second FOV aligned with the wafer edge of the first side lateral surface of the wafer and the second camera capturing images of the wafer edge as the wafer rotates to monitor the wafer edge position and determining when the wafer shift has occurred,

18. A semiconductor processing method comprising:
attaching a wafer to a rotatable wafer stage, the wafer having a circular shape with a wafer center, a wafer edge located at a wafer perimeter radially offset from the wafer center, a first side lateral surface and a second side lateral surface opposite the first side lateral surface;
aligning a first field of view (FOV) of a first camera with the wafer, the first FOV orthogonally aligned with the first side lateral surface of the wafer and the first FOV laterally offset from the wafer center to include a first radial portion of the wafer;
aligning a second field of view (FOV) of a second camera with the wafer, the second FOV orthogonally aligned with the first side lateral surface of the wafer and the second FOV laterally offset from the wafer center to include a second radial portion of the wafer, which in combination with the first FOV, provides a radial portion of the wafer extending from the wafer center to a wafer edge;
rotating the wafer stage and wafer attached thereto about a wafer center axis orthogonal to the first side lateral surface;
as the wafer rotates, using the first camera and the second camera to radially image the wafer to capture a first complete image of the first side lateral surface while continuously laterally moving the wafer stage and a wafer edge position when a wafer shift is detected to provide the constant radially imaging alignment position of the wafer center; and
performing an analysis of one or both of the first complete image and a second complete image generated from the first complete image to detect one or more features on the first side lateral surface of the wafer.

19. The method of claim 18, wherein the second complete image is generated by rotating the plurality of captured radial line scan images of the first side lateral surface at a plurality of respective rotational angles of the wafer stage associated with capturing each of the plurality of captured radial line scan images of the first side lateral surface.

20. The method of claim 18, wherein the first camera is a line scan camera and the method further comprises:
the wafer stage and wafer attached thereto rotated at a constant rotational speed while monitoring the wafer edge position and laterally moving the wafer stage and the wafer edge position when the wafer shift is detected to provide a constant radially imaging alignment position of the wafer center; and
calibrating a plurality of line scan camera pixel locations to the first FOV radial portion and the second FOV radial portion of the wafer radially oriented along an axis from the wafer center to the wafer edge.
